(19) United States
(12) Patent Application Publication
(10) Pub. No.: US 2007/0026225 A1
(43) Pub. Date: Feb. 1, 2007

(54) Primer composition for high temperature belts

(76) Inventors: Jiann-Hsing Chen, Fairport, NY (US); Joseph A. Pavlisko, Pittsford, NY (US); David D. Putnam, Fairport, NY (US); Robert A. Lancaster, Hilton, NY (US)

Correspondence Address: Paul A. Leipold;Patent Legal Staff, Eastman Kodak Company, 343 State Street, Rochester, NY, 14650-2201, US

(21) Appl. No.: 11/192,632

(22) Filed: Jul. 29, 2005

(51) Int. Cl. B32B 27/38; B32B 27/34; B32B 27/08; B32B 33/00

(52) U.S. Cl. 428/336; 428/473.5; 428/474.4; 428/414; 399/333; 428/339; 428/447; 428/421; 428/422

(57) ABSTRACT

A fuser belt comprising in order a substrate comprising a high temperature thermoset polymer, an epoxy primer layer comprising an epoxy resin having the following structure:

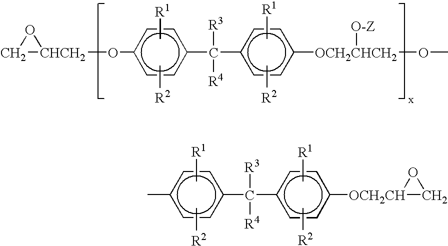

where R¹ and R² are each independently H or an alkyl group containing 1 to about 4 carbon atoms, and R³ and R⁴ are each independently H, F, or an alkyl group containing 1 to about 4 carbon atoms, Z is a carbonyl cross-linking group, and x is an integer from 1 to about 10
and said epoxy priming layer also comprising an anhydride crosslinking agent cyclic mono anhydride or dianhydride having the following structure: 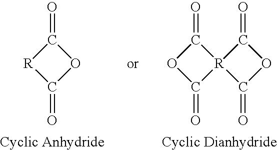 and mixture thereof where R is an alkyl group containing 6 to about 8 carbon atoms and a low surface energy polymeric release coating.

### CROSS REFERENCE TO RELATED APPLICATION

Reference is made to commonly assigned U.S. patent application Ser. No. ______ (Docket 89484) filed concurrently herewith, entitled “Epoxy Primer Layer For Fusing Belt” by Chen et al, the teachings of which are incorporated herein by reference.

### FIELD OF THE INVENTION

The present invention relates to a composite tubular article for use as the fusing belt in an image forming device. This invention relates in general to electrophotographic imaging and in particular, to a toner fuser member. More particularly, a toner fuser belt for use with electrophotographic apparatus including a thermally conductive substrate through which heat is applied; a toner release layer formed over the substrate; and an adhesion promoting layer including an epoxy primer layer which is stable at fusing temperatures provided between the substrate and the toner release layer and wherein the an epoxy primer layer is selected to provide good adhesion between the substrate and the toner release layer.

### BACKGROUND OF THE INVENTION

In electrostatographic imaging and recording processes such as electrophotographic copying, an electrostatic latent image formed on a photoconductive surface is developed with a thermoplastic toner powder, which is thereafter fused to a receiver. The fuser member can be a roll, belt or any surface having the suitable shape for fixing thermoplastic toner powder to the receiver. The fusing step commonly consists of passing the receiver, for example, a sheet of paper on which toner powder is distributed in an imagewise pattern, through the nip of a pair of rolls. At least one of the rolls is heated; in the case where the fuser member is a heated roll, a smooth resilient surface is bonded either directly or indirectly to the core of the roll. Where the fuser member is in the form of a belt, it is preferably a flexible endless belt having a smooth, hardened outer surface that passes around the heated roller. A persistent problem with electrostatographic fusing systems, known as offset, is the adhesion of heat-softened toner particles to the surface of the fuser member rather than the receiver during passage through the rolls. Any toner remaining adhered to the fuser member can cause a false offset image to appear on the next sheet that passes through the rolls and can also degrade the fusing performance of the member. Another possible problem is degradation of the member surface caused by continued heating, which results in an uneven surface and defective patterns in thermally fixed images.

Toner fuser rolls are composed of a cylindrical core that may include a heat source in its interior, and a resilient covering layer formed directly or indirectly on the surface of the core. A thin layer of a suitable primer is may be coated on the surface of the core in order to improve bonding of the layer. Roll covering layers are commonly made of fluorocarbon polymers or silicone polymers, for example, poly(dimethylsiloxane) polymers of low surface energy, which minimizes adherence of toner to the roll. Frequently, release oils such as poly(dimethylsiloxanes) are also applied to the fuser roll surface to prevent adherence of toner to the roll. Such release oils may interact with the resilient layer upon repeated use and in time cause swelling, softening, and degradation of the roll. Silicone rubber covering layers that are insufficiently resistant to release oils and cleaning solvents are also susceptible to delamination of the roll cover after repeated heating and cooling cycles.

Toner fuser belts are composed of a continuous flexible material having superior resistance to heat and a smooth surface. The belt substrate can be metallic or polymeric. The surface of the belt is composed of a thinly coated, low surface energy polymer such as a fluorocarbon or a silicone resin. There is a need for coating compositions which adhere strongly to the belt and form a hard, tough surface that is resistant to wear and cracking. The surface should also be resistant to cleaning solvents and fluids.

In electrostatographic imaging processes dry developers can be used to form an image on a receiving surface such as a sheet of paper. Dry developers usually comprise a toner powder and carrier particles. Carrier particles and toner particles have different triboelectric values. As the developer mixture is agitated, the particles rub together and the toner and carrier particles acquire opposite electric charges and cling together. In the subsequent development step the somewhat higher opposite charge of the electrostatic latent image draws the colored toner from the carrier and develops the image. Various addenda are frequently used to improve the properties of the toner and carrier particles.

Toners comprise, as a major component, the binder and, as minor components, a colorant and a charge control agent. The binder can be any resin having properties suitable for dry toners. Many such resins are known, but thermoplastic resins that are fixable by fusing are especially useful. When a dry toner powder image is transferred from one surface to another, defects in the image can occur. U.S. Pat. No. 4,758,491 teaches that the addition of low surface energy addenda, especially polymers containing organopolysiloxane segments, may alleviate such defects.

Carrier particles comprise magnetizable irregular particles that are usually coated with a film of a polymeric material, which helps develop the triboelectric charge and aids the transfer of the toner. The coating material must adhere well to the carrier particle because the toner charge decreases as the polymer wears off. Polymers with low surface energy properties are especially useful for coating carrier particles.

Recent electrophotographic apparatus and processes are disclosed in U.S. Pat. Nos. 5,089,363 and 5,411,779, the disclosures of which are incorporated herein by reference. U.S. Pat. No. 5,411,779 describes an apparatus having an image-fixing belt with a polyimide resin inner layer and a fluoroplastic outer layer that produces unglossed, matte images. Other fuser belt systems are described in U.S. Pat. Nos. 5,200,284; 5,233,008; 5,330,840; 5,362,833; and 5,529,847, the disclosures of which are incorporated herein by reference.

U.S. Pat. No. 4,027,073 teaches the use of silsesquioxanes as abrasion resistant coatings on organic polymers. Typical applications include scratch resistant coatings on acrylic lenses and transparent glazing materials; the cited patent teaches that a preferred thickness for good scratch resistance is from 2 to 10 μm. U.S. Pat. No. 4,439,509 teaches photoconducting elements for electrophotography that have silsesquioxane coatings having a thickness of 0.5 to 2.0 μm, which is purported to optimize electrical, transfer, cleaning and scratch resistance properties. This teaching contrasts with that of U.S. Pat. No. 4,027,073, which teaches that a preferred thickness of a silsesquioxane layer for good scratch resistance is from 2 to 10 μm. U.S. Pat. No. 4,923,775 teaches that methylsilsesquioxane is preferred since it produces the hardest material in comparison to other alkylsilanes. U.S. Pat. No. 4,595,602 teaches a conductive overcoat of cross-linked “siloxanol-colloidal silica hybrid” having a preferred thickness of from 0.3 to 5.0 μm. U.S. Pat. No. 5,778,295 discloses a toner fusing belt that has an intermediate layer of highly crosslinked silicone resin and a silsesquioxane surface layer on a polyimide resin belt. U.S. Pat. No. 6,537,741 discloses a fusing belt that is used to fuse a coating to a photographic element and comprises a surface layer formed from a cured silsesquioxane composition and an epoxy primer adhesive layer between the surface layer and the substrate.

The ferrotyping belt used for the production of high gloss toner images typically consists of a metal or an organic polymeric substrate on which is coated a release layer. The toner is generally fused in a heated nip to a receiver, which then continues to travel along the belt without releasing until the toner is cool. To avoid the use of a release oil, the release layer of the fuser belt must have low surface energy.

Toner fuser belts are composed of a continuous smooth, heat-resistant, flexible material on a metallic or polymeric substrate. A release layer applied to the belt substrate is a thinly coated, low surface energy polymer such as a fluorocarbon or a crosslinked silicone resin. Such release layers, however, often display poor mechanical properties, including inadequate adhesion to the metal support, and are susceptible to rapid wear upon repeated contact with abrasive receiving sheets such as bond paper or uncoated laser print paper.

### PROBLEM TO BE SOLVED BY THE INVENTION

While fuser belts described in the aforementioned prior art provide high gloss and good release of the fused toner images there is a need to improve the adhesion of the toner release layer to the substrate to promote belt life. More particularly, there remains an ongoing need for fuser belts having durable surface layer compositions that adhere well to the substrate, form a hard, tough surface that is resistant to wear, cracking and solvents, and are capable of producing multiple high quality, high gloss toner images, including multicolor images. This need is well met by the toner fuser belt of the present invention.

### SUMMARY OF THE INVENTION

It is an object of the invention to provide a fuser belt containing an epoxy primer layer for adhering the toner release layer to the substrate

It is another object to provide to provide a fuser belt that has improved wear resistance and excellent release properties.

It is a further object to provide a fuser belt that provides fused toner images having high gloss.

These and other objects of the invention are accomplished by:

A fuser belt comprising in order a substrate comprising a high temperature thermoset polymer, an epoxy primer layer comprising an epoxy resin having the following structure:

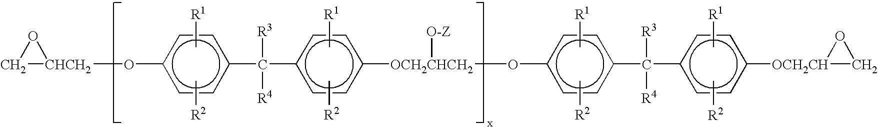

where R¹ and R² are each independently H or an alkyl group containing 1 to about 4 carbon atoms, and R³ and R⁴ are each independently H, F, or an alkyl group containing 1 to about 4 carbon atoms, Z is a carbonyl cross-linking group, and x is an integer from 1 to about 10

and said epoxy priming layer also comprising an anhydride crosslinking agent having the following structure:

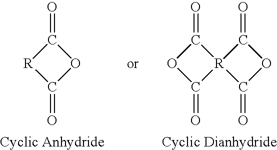

cyclic anhydride or dianhydride and mixture thereof.

where R is an alkyl group containing 6 to about 8 carbon atoms and a low surface energy polymeric release coating.

### ADVANTAGEOUS EFFECT OF THE INVENTION

The invention provides a fuser belt that has high gloss, long-life, and good release of the fused toner images. The life of the fuser belts is typically greater than 150 K fused toner images

### BRIEF DESCRIPTION OF THE DRAWINGS

FIG. 1 shows a fuser belt system which is effective for fusing or fixing toner to a receiver surface; and

FIG. 2 is a cross-sectional view taken along lines II-II of the fuser belt of FIG. 1 and illustrating the present invention.

### DETAILED DESCRIPTION OF THE INVENTION

Fuser belts of this invention can be any size and can be used in any fuser belt system which comprises a fuser belt. Preferably the fuser belt system comprises a fuser belt which is trained around two or more rollers, and is in pressurized contact with another fuser member, preferably either another fuser belt or a fuser roller. Fuser belts of this invention can be used to contact the toner-bearing or non-toner-bearing side of a receiver.

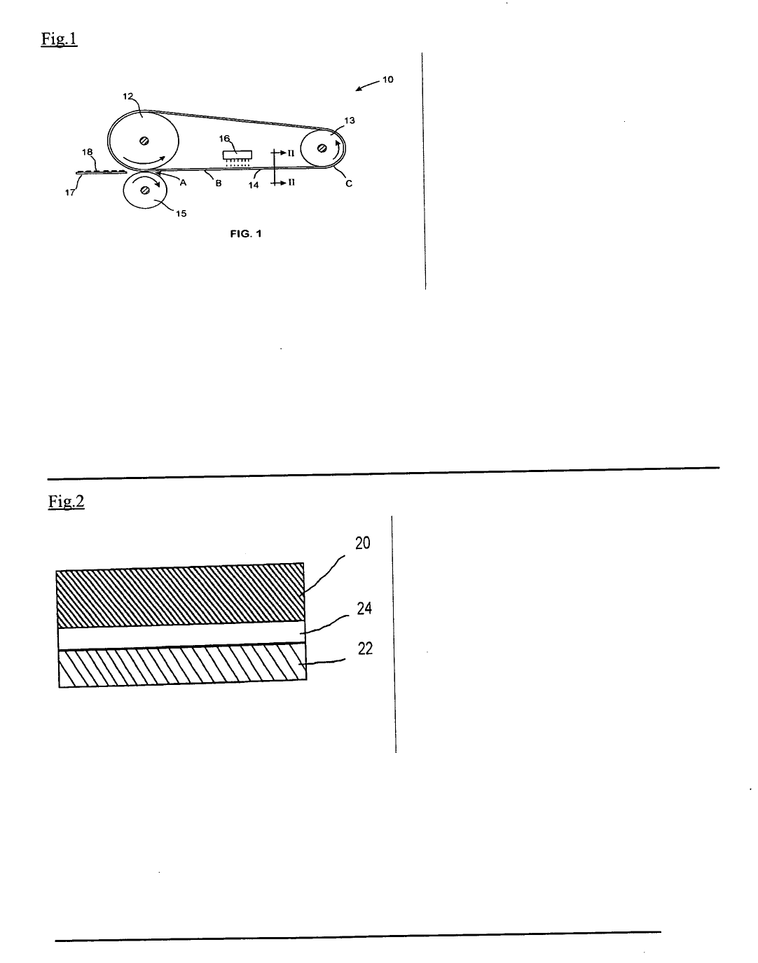

FIG. 1 illustrates a typical configuration of a fuser belt system 10 using a fuser belt 14 in the form of a web. As will be subsequently described, the fuser belt 14 has an improved epoxy primer layer. The fuser belt system 10 includes a heating roller 12 which also drives the web in conjunction with a roller 13 along an endless path. More particularly, the fuser belt 14 is trained about both the heating roller 12 and roller 13. A backup pressure roller 15 is biased against the heating roller 12. The fuser belt 14 is cooled by impinging air provided by blower 16 disposed above fuser belt 14. In operation, a receiver 17 bearing the unfused toner 18 is transported in the direction of the arrow into the nip between heating roller 12 and backup pressure roller 15, which can also or alternatively be heated if desired, where it enters a fusing zone A extending about 0.25 to 2.5 cm, preferably about 0.6 cm laterally along the fuser belt 14. Following fusing in the fusing zone A, the fused image then continues along the path of the fuser belt 14 and into the cooling zone B about 5 to 50 cm in length in the region after the fusing zone A and to roller 13. In the cooling zone B, fuser belt 14 is cooled slightly upon separation from heating roller 12 and then additionally cooled in a controlled manner by air that is caused to impinge upon fuser belt 14 as the fuser belt 14 passes around roller 13 and is transported to copy collection means such as a tray (not shown). Receiver 17 bearing the fused image is separated from the fuser belt 14 within the release zone C at a temperature where no toner image offset occurs. Separation by selecting roller 13 to have a relatively small diameter, e.g. a diameter of about 2.5 to 4 cm. As a result of passing through the three distinct zones, i.e. the fusing zone A, cooling zone B and release zone C, the fused toner image exhibits high gloss. The extent of each of the three zones and the duration of the time the toner image resides in each zone can be conveniently controlled simply by adjusting the velocity or speed of fuser belt 14. The velocity of the fuser belt 14 in a specific situation will depend on several variables, including, for example, the temperature of the fuser belt 14 in the fusing zone A, the temperature of the cooling air in the cooling zone B, and the composition of the toner particles.

Turning now to FIG. 2, a cross-sectional view of the fuser belt 14 according to the present invention includes a thermally conductive substrate 20 through which heat is applied. The substrate 20 can include a polymer, such as, polyimide, polyester, polycarbonate, and polyamide (p-phenylene terephthalamide), polyamide-imide, polyether-imide or mixtures or combinations thereof. The substrate 20 can be a smooth sheet or a meshed material, preferably it is a smooth sheet. The substrate 20 is preferably a seamless endless belt; however, belts having seams can also be used. The thickness of the substrate 20 is preferably 50 to 200 micrometers, more preferably 50 to 100 micrometers and most preferably 50 to 75 micrometers. Other materials which are also conductive will suggest themselves to those skilled in the art. In accordance with a preferred form of the present invention, the fuser belt 14 is a seamless, high temperature thermoset polymer belt having a novel combination of coatings which will be described hereinafter. An important advantage of a high temperature thermoset polymer comprises polyamide (Du-pont, Kelvar), polyimide, polyamide-imide (Amoco, Torlon) and polyether-imide (GE, Ultem) of the following structure for the coated belt is that it can be fabricated as a seamless belt, thus avoiding the disadvantage of belts having seams, in that the seams become visible in the toner image.

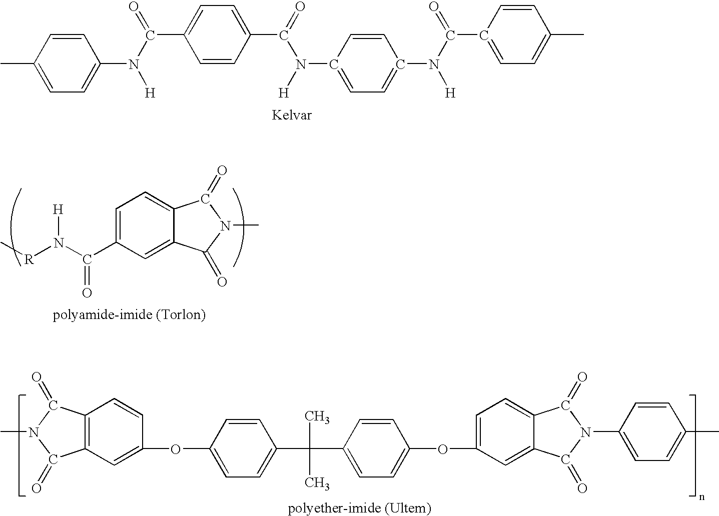

A polyimide belt is also highly flexible and can be more easily handled without forming kinks than a metal belt. A polyimide belt also adheres well to silicone resin coatings and is less subject to delamination than other belt materials. In general, therefore, a polyimide belt is less subject to image defects than fusing belts of other materials.

Polyimides useful as fusing belts are disclosed in U.S. Pat. No. 5,411,779, dated May 2, 1995, which is incorporated herein by reference. As disclosed in the cited patent, the polyimide can be prepared in tubular or belt form by coating a poly(amic acid) solution on the inner circumference of a cylinder and imidizing the poly(amic acid) to form a tubular inner layer of the polyimide resin. The poly(amic acid) can be obtained by reacting a tetracarboxylic dianhydride or derivative thereof with an approximately equimolar amount of a diamine in an organic polar solvent. Examples of tetracarboxylic dianhydrides, diamines, solvents and reaction procedures are disclosed in the cited patent, especially in columns 4-6 and in the numbered examples.

Although polyimide belts have the advantages mentioned above, an uncoated polyimide belt has less than optimum release qualities for fused thermo-plastic toners. A need exists for a coating that releases well from fused thermo-plastic toner and that adheres well to a polyimide belt under the stress of repeated heating, cooling and flexing. The present invention provides such a coating, not in a single layer, but in a novel combination of layers of materials. The polyimide belt is a crosslinked polymer of diphenyl ether amine and pyromellitic dianhydride having the formula:

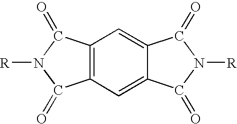

where R is diphenyl ether

A toner release layer 22 which comprises a low surface energy polymeric release coating is formed over the substrate 20. The toner release layer 22 will be described in more detail later. In accordance with the present invention, an adhesion promoting layer 24 including a epoxy primer layer comprising an epoxy resin and an anhydride crosslinking agent which is stable at fusing temperatures up to 200° C. is provided between the substrate 20 and the toner release layer 22 and wherein the material epoxy primer layer comprising an epoxy resin and an anhydride crosslinking agent is selected to provide good adhesion between the substrate 20 and the toner release layer 22. The toner release layer 22 can include a crosslinked silicone resin coating applied over the epoxy primer layer 24. A epoxy primer layer comprising an epoxy resin and an anhydride crosslinking agent are selected for the adhesion promoting layer 24 because of their availability, excellent coating and film forming properties, and excellent adhesion to a wide variety of substrates.

The epoxy primer layer includes a curable epoxy resin, which preferably is a crosslinked, glycidyl end-capped bisphenolic polymer having the formula 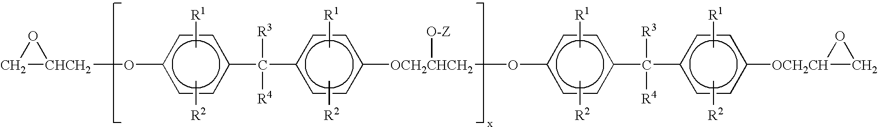
where R¹ and R² are each independently H or an alkyl group containing 1 to about 4 carbon atoms, and R³ and R⁴ are each independently H, F, or an alkyl group containing 1 to about 4 carbon atoms, Z is a carbonyl cross-linking group, and x is an integer from 1 to about 10. The epoxy primer layer also includes an anhydride crosslinking agent having the following structure:

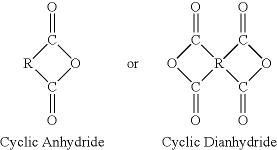

cyclic mono anhydride or dianhydride and mixture thereof.

where R is an alkyl group containing 6 to about 8 carbon atoms.

In accordance with the present invention, a epoxy resin is selected from the group consisting of diglycidylether bisphenol A:

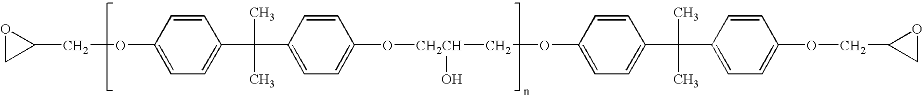

n is from 1 to 20
and anhydride crosslinking agent is selected from having the structure of pyromellitic dianhydride or hexahydrophthalic anhydride or mixture of thereof

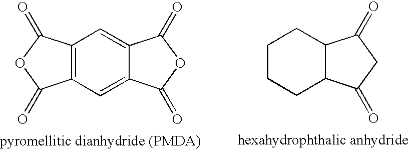

The bisphenolic epoxy resin is cross-linked by a difunctional dicarbonylsubstituted crosslinking agent, preferably a dianhydride such as pyromellitic anhydride or a diimide. The weight ratio of epoxy resin: crosslinking agent is preferably about 1:0.1 to about 1:1, more preferably about 1:0.4 to about. 1:0.8. Preferably, the thickness of the epoxy primer layer has a thickness of about 0.001 μm to about 2 μm, more preferably, about 0.01 μm to about 1.0 μm.

Bisphenol epoxy resins useful in the present invention are commercially available and include, for example, HYSOL™ EA 9369 QT, a crosslinked Bisphenol F epoxy resin, available from Dexter Aerospace, and STYCAST™ W-66 black resin and crosslinking catalyst 17M-1, a two-component formulation from Emerson & Cuming Inc., Lexington Mass.

The low surface energy polymeric release coating 22 preferably comprises at least one material selected from the group consisting of silicone rubber, fluoroelastic polymers, phosphazine, polytetrafluoroethylene polymers and mixtures thereof. In accordance with the current invention, the low surface energy polymeric release coating 22 that are applied onto epoxy primer layers 24 are described in commonly-assigned U.S. Pat. No. 5,778,295, which is incorporated herein by reference. The toner release layer formed from a composition comprising a slisesquioxane having the following structure:

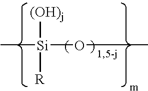

j is from 0 to 0.5, mis greater than 10, R is methyl, propyl, aminopropyl, glycidoxypropyl

Silsesquioxanes are a class of inorganic/organic glasses that can be formed at moderate temperatures by a procedure commonly referred to as a “sol-gel” process. In the sol-gel process, silicon alkoxides are hydrolyzed in an appropriate solvent, forming the “sol.” The solvent is then removed, resulting in the formation of a cross-linked “gel.” A variety of solvents can be used, aqueous, aqueous-alcoholic, and alcoholic solvents being generally preferred. Silsesquioxanes are conveniently coated from acidic alcohols, since the silicic acid form, RSi(OH)₃, is quite stable in solution for months under ambient conditions. The extent of condensation is related to the amount of curing a sample receives, temperature and time being among the two most important variables.

Silsesquioxanes can be represented by the formula (RSiO_{1.5})ₙ, where R is an organic group and n is the number of repeating units. Thus, the prefix “sesqui” refers to a one and one-half stoichiometry of oxygen. The polymers can be prepared by the hydrolysis and condensation of trialkoxysilanes. (RSiO_{1.5})ₙ, which is sometimes written [Si(O_{0.5})₃ Rₙ], is a useful shorthand for silsesquioxanes but, except for fully cured silsesquioxane, it does not totally characterize the material. This is important, since silsesquioxanes can be utilized in an incompletely cured state. An additional nomenclature, derived from one described in R. H. Glaser, G. L. Wilkes, C. E. Bronnimann; Journal of Non-Crystalline Solids, 113 (1989) 73-87; uses the initials M, D, T, and Q to designate silicon atoms bonded to 1, 2, 3, or 4 oxygen atoms, respectively. The designation T is subdivided to indicate the number of —Si—O—Si— bonds, from 0 to 3, contained in the silsesquioxane, i.e., T⁰, T¹, T², and T³ having the structure:

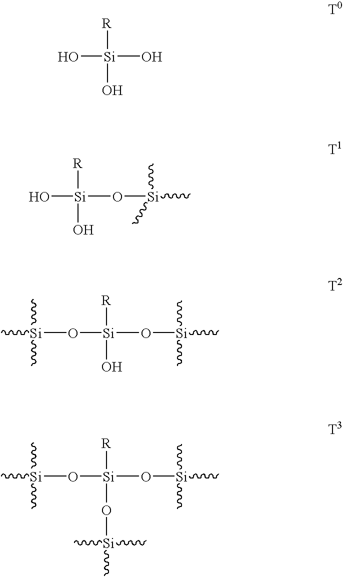

In fully cured silsesquioxanes, substantially all silicons are included in T³ structures. The extent of curing of the silsesquioxane can be quantified as the ratio of T² to T³. The value of this T² /T³ ratio decreases with an increase in cure, and vice versa. In the silsesquioxanes having the most advantageous properties for inclusion in a toner fusing belt surface layer in accordance with the invention, the ratio of carbon to silicon atoms, i.e., the C:Si ratio, is greater than about 2:1, and the T² /T³ ratio is from about 0.5:1 to about 0.9:1. The silsesquioxane is a large oligomer or a polymer typically containing more than 10 silsesquioxane subunits, although theoretically there is no upper limit on the number of subunits.

In the silsesquioxan having the most advantageous properties as a fusing belt toner release layer in accordance with the invention can be respresented by the following structure:

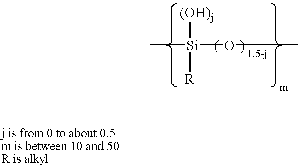

A useful material for preparation of the toner release surface layer of the present invention is GE AS 4700, a silsesquioxane sol-gel that is derived from methyltrimethoxysilane and is available from General Electric Company. Preferably, the toner release surface layer has a thickness of about 1 μm to about 20 μm, more preferably, about 3 μm to about 15 μm. The methylsilsesquioxane has a weight average molecular weight of between 5,000 and 50,000

The substrate 20 of the fuser belt 14 is preferably solvent cleaned prior to coating the epoxy primer layer 24. There are a number of ways to coat epoxy priming layers. They include coating from organic solvent or aqueous media using conventional coating techniques such as ring coating, dip coating and spray coating. After coating the epoxy primer layer 24 should be dried typically by air drying, although it can be briefly put into a heated enclosure. After drying, the epoxy primer layer 24 is cured by high temperature heating (typically 100-200° C. for 10 min-3 hours).

The epoxy resin and the anhydride crosslinking agent selected for use in the epoxy primer layer 24 must be thermally stable at fusing temperatures employed in the electrophotographic apparatus. Typically these fusing temperatures are greater than 120° C. The suitability of a particular aliphatic polyurethane for use in the adhesion promoting layer 24 can be determined by the following simple test. A 1.0 μm thick layer of an epoxy primer layer is coated on the substrate 20. This structure is then placed in an oven and heated at 250° C. for 20 hours. The structure is then removed from the oven and the adhesion promoting layer 24 is visually observed for signs of degradation. Degradation would be apparent if there was discoloration, cracking, bubble-formation, surface deformation, loss of adhesion to the substrate or loss of transparency. The epoxy primer layer which form the adhesion promoting layer 24 and do not show any signs of degradation in this test are suitable for use in the present invention.

After curing, the epoxy primer layer 24 the toner release layer 22 is coated thereon. The toner release layer 22 is preferably prepared by making a solvent solution and coating the solution onto the clean substrate 20 by conventional coating techniques, such as, ring coating, dip coating, and spray coating. The coated substrate 20 is preferably placed in a convection oven at a temperature of 150° C. to 350° C., for 10 minutes to 6 hours, preferably causing the silsesquioxane to undergo condensation reactions to form the highly crosslinked silsesquioxane. The higher the cure temperature the shorter the cure time.

The invention has numerous advantages. The invention provides a fuser belt that has high gloss, long-life, and good release of the fused toner images. The life of the fuser belts is typically greater than 150 K fused toner images.

These and other advantages will be apparent from the detailed description below.

The following examples illustrate the practice of this invention. They are not intended to be exhaustive of all possible variations of the invention. Parts and percentages are by weight unless otherwise indicated.

### EXAMPLES

### Example 1

### Preparation of Epoxy Primer Layer Solution for Fuser Roller

A solution of 60 gm of ST4CAST™ W-66 epoxy resin in 240 gm THF is stirred overnight to give Part A.

A solution of 27 gm of the mixture of the pyromellitic dianhydride and hexahydrophthalic anhydride (Pyromellitic dianhydride : hexahydrophthalic anhydride=2:1 mole ratio) in 273 gm THF is shaken for 5 minutes to give Part B.

A polyimide belt substrate manufactured by Nitto Denko is cleaned with pressurized air to remove dust, cleaned first with acetone and then with alcohol using SPEC-WIPE™ and knitted polyester clean room wipers, and again cleaned with pressurized air. A solution of 15.38 gm of Part A and 15.38 gm of Part B was mixed for 5-10 minutes, then ring coated on the cleaned P.I. belt. The coated substrate is dried for 30 minutes, ramped to a temperature of 170° C. for 4 hours, and cured at 170° C. for 2 hours.

### Example 2

### Preparation of Toner Fuser Belt with Silsesquioxane Surface Layer I

The silsesquioxane sol-gel GE AS4700 is filtered at room temperature by gravity through a Whatman glass microfibre filter GF/A.

Onto the cured epoxy primer layer P.I. belt, described in example 1, is coated with the GE AS4700 silsesquioxane sol-gel. This toner release layer is dried for 30 minutes at room temperature, ramped to a temperature of 150° C. over a period of 4 hours, held at 150° C. for 2 hours, and cooled to provide a fuser belt I-1.

### Example 3

### Preparation of Toner Fuser Belt with Silsesquioxane Surface

To a 2 liter Erlenmeyer flask equipped with magnetic stirrer is added 220.8gm of propyltrimethoxysilane, 73.2 gm of metyltrimethoxysilane, 73.2 of 3-glycidoxypropyl-trimethoxysilane, and 30.0 gm of 3-aminopropyltrimethoxysilane. After stirring for a few minutes, 64.8 gm of glacial acetic acid followed by 72 gm of water, are added dropwise from an additional funnel, and 122.79 gm distilled water is added from an additional funnel. The reaction mixture becomes exothermic and is cloudy at first but become clear after about half of water has been added. Following addition of the water, the flask is covered, and its contents are stirred overnight. Then 42 gm of a 70 wt % aqueous suspension of Ludox™ silica gel, whose pH has been adjusted from 8.9 to 4.3 by the addition of a few drops of acetic acid, is added dropwise. The mixture is again stirred overnight, and 627.6 gm of ethanol is added at a low flow rate through a funnel to the reaction mixture to obtain a silsesquioxane composition that has solids content of about 33 wt %.

The ready to coat silsesquioxane solution is filtered at room temperature by gravity through a Whatman glass microfibre filter GF/A.

Onto the cured epoxy primer layer polyimide belt described in example 1 is coated and cured same as example 2 to provide a fuser belt I-2.

### Example 4

### Preparation of Comparison Toner Fuser Belt without Epoxy Primer Layer

The cleaned polyimide belt, which described in example 1, is coated with primer GE SHP 401, as recommended by General Electric Co, and ring coated the silsesquioxane GEAS4700 as described in example 2. The coated belt then dried and cured at the same condition as described in example 2 to provide a fuser belt C-1.

The adhesion of the coated fuser belt I-1, I-2 of the invention and C-1 of the comparison is evaluated using the method of ASTM D 3359-95A. Comparison belt C-1, in which the silsesquioxane layer is coated on a substrate previous coated with manufacture-recommended primer, shows a substantial delamination, >65% for a B rating. Using the same test method, the belts of theI-1 I-2 all exhibit no delamination, reflected in highest rating 5B, and demonstrate the excellent adhesion of epoxy primer layer. The result is presented in Table 1.

Gloss measurements are made on belts I- 1, I-2 of the invention and C-1 of comparison belt.

The gloss measurements were made according to ASTM-523-67 using a BYK Garden Micro Gloss Meter set at 20 digresses. The gloss value of each belt is also presented in Table 1.

TABLE 1

| | | | Delami- | |
|---|---|---|---|---|
| | Surface release | | nation/ | |
| Fuser Belt | layer | Primer layer | Adhesion | G-20Gloss |
| I-1 (Invention) | GE AS4700 | PartA + PartB | 0%, 5B | 112 |
| I-2 (Invention) | Silsesquioxane | PartA + PartB | 0%, 5B | 104.9 |
| C-1 | GE AS 4700 | SHP 401 | >65%, | 110 |
| Comparison | | | 0B | |

Thus, the present invention provides durable toner release layer that adhere very well to a polyimide substrate without delamination.

The invention has been described in detail with particular reference to certain preferred embodiments thereof, but it will be understood that variations and modifications can be effected within the spirit and scope of the invention.

### PARTS LIST

10 fuser belt system
12 heating roller
13 roller
14 fuser belt
15 pressure roller
17 receiver
20 thermally conductive substrate
22 toner release layer, low surface energy polymeric release coating
24 epoxy primer layer

1. A fuser belt comprising in order a substrate comprising a high temperature thermoset polymer, an epoxy primer layer comprising an epoxy primer layer having the following structure: 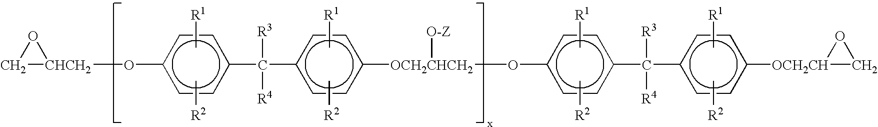
where R¹ and R² are each independently H or an alkyl group containing 1 to about 4 carbon atoms, and R³ and R⁴ are each independently H, F, or an alkyl group containing 1 to about 4 carbon atoms, Z is a carbonyl cross-linking group, and x is an integer from 1 to about 10
and said epoxy primer layer also comprising an anhydride crosslinking agent cyclic mono anhydride or dianhydride having the following structure: 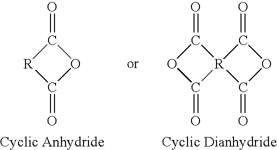
and mixture thereof.
where R is an alkyl group containing 6 to about 8 carbon atoms and a low surface energy polymeric release coating.

2. The belt of claim 1 wherein said thermoset polymer comprises polyamide, polyimide, polyamide-imide or polyether-imide

3. The belt of claim 2 wherein said thermoset polymer comprises polyamide-imide of the following structure:

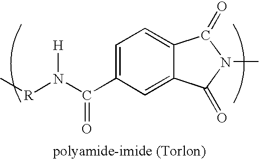

4. The belt of claim 2 wherein said thermoset polymer comprises polyether-imide of the following structure:

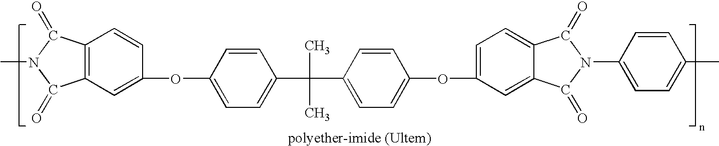

5. The belt of claim 1 wherein said thermoset polymer comprises a polyimide.

6. The belt of claim 1 wherein said thermoset polymer comprises polyimide of the following structure 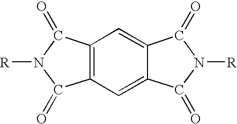
where R is diphenyl ether

7. The belt of claim 1 wherein said thermoset polymer comprises a composition selected the group consisting of Kevlar (p-phenylene terephthalamide) of the following structure:

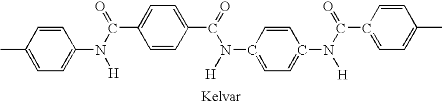

8. The belt of claim 1 wherein said a low surface energy polymeric release coating comprises silsesquioxane.

9. The belt of claim 8 wherein said a low surface energy polymeric release coating comprises methyl silsesquioxane.

10. The belt of claim 1 wherein said high temperature thermoset polymer is a woven belt.

11. The belt of claim 1 wherein said epoxy peimer layer is consisting of diglycidylether bisphenol A: 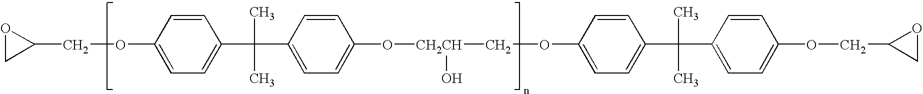
n is from 1 to 20
and anhydride crosslinking agent having the structure of pyromellitic dianhydride or hexahydrophthalic anhydride or mixture thereof

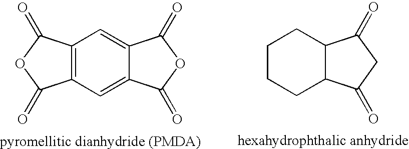

12. The belt of claim 1 wherein structures epoxy resin and dianhydride crosslinking agent have a ratio of between 1:0.1 and 1:1.

13. The belt of claim 1 wherein structures of epoxy resin and dianhydride crosslinking agent have a ration from 1:0.4 and 1:0.8.

14. The belt of claim 8 wherein the silsesquioxane having a composition comprising a ratio of T²:T³ is between 0.5:1 to 0.9:1.

15. The belt of claim 8 wherein said silsesquioxane layer has a thickness of between 3 μm to 15 μm.

16. The belt of claim 8 wherein said silsesquioxane has a weight average molecular weight of between 5,000 and 50,000.

17. The belt of claim 8 wherein said silsesquioxane having structure:

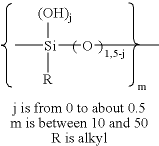

18. The belt of claim 1 wherein said epoxy primer layer has a decomposition temperature of above 100° C.

19. The belt of claim 1 wherein said epoxy primer layer has a decomposition temperature of above 200° C.

20. The belt of claim 1 wherein said the high temperature thermoset polymer layer has a thickness of between 50 μm to 200 μm.

21. The belt of claim 1 wherein said low surface energy release coating comprises 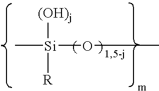
j is from 0 to 0.5, mis greater than 10, R is methyl, propyl, aminopropyl, glycidoxypropyl.

22. The belt of claim 1 wherein said low surface energy release coating comprises at least one material selected from the group consisting of silicone rubber, fluoroelastic polymers, phosphazine, polytetrafluoroethylene polymers and mixtures thereof.
